(19) United States
(12) Patent Application Publication
(10) Pub. No.: US 2025/0222639 A1
(43) Pub. Date: Jul. 10, 2025

(54) EXTRUSION DIE FOR FORMING PATTERNED PRODUCT

(71) Applicant: NIPPON LIGHT METAL COMPANY, LTD., Tokyo (JP)

(72) Inventor: Peizheng LIN, Shizuoka (JP)

(73) Assignee: NIPPON LIGHT METAL COMPANY, LTD., Tokyo (JP)

(21) Appl. No.: 19/090,426

(22) Filed: Mar. 26, 2025

Related U.S. Application Data
(63) Continuation of application No. PCT/JP2023/018931, filed on May 22, 2023.

(30) Foreign Application Priority Data
Sep. 27, 2022 (JP) 2022-153396

(51) Int. Cl. B29C 48/00; B29C 48/09; B29C 48/32

(52) U.S. Cl. CPC B29C 48/002; B29C 48/32; B29C 48/09

(57) ABSTRACT

An extrusion die for applying patterns to multiple surfaces of a hollow intermediate product formed of thermoplastic material. The extrusion die comprises an upper die with a mandrel having a bearing to form a hollow space in the intermediate product; an intermediate die with a bearing to shrink external dimensions of the intermediate product; and a lower die supporting the upper die through the intermediate die. The lower die includes a first lower die with a first patterning tool that applies a pattern to surfaces of one pair of opposing side walls of the intermediate product, and a second patterning tool that applies a pattern to surfaces of another pair of opposing side walls of the intermediate product. Both patterning tools rotate with the intermediate product. A second lower die joins the first lower die to fix the second patterning tool.

### CROSS-REFERENCE TO RELATED APPLICATION

This application is a continuation of PCT International Application No. PCT/JP2023/018931, filed on May 22, 2023, which claims priority under 35 U.S.C § 119(a) to Japanese Patent Application No. 2022-153396, filed on Sep. 27, 2022. Each of the above application(s) is hereby expressly incorporated by reference, in its entirety, into the present application.

### BACKGROUND

### Technical Field

The present invention relates to an extrusion die for forming a patterned hollow product in which a predetermined pattern is applied to a plurality of surfaces using thermoplastic material such as aluminum alloy.

### Related Art

Since aluminum alloy has an excellent workability, aluminum alloy is suitable for forming products having various cross-sectional profiles. Therefore, aluminum alloy is widely used as a material of extrusion processing to form products of various shapes.

For example, a rickrack pattern, a wavy pattern, a grid pattern may be applied to a surface of an aluminum alloy product by the extrusion processing.

In the conventional art, as an extrusion tool, there is known an extrusion die for applying patterns to two of surfaces of a hollow product formed of thermoplastic material extruded continuously from a feeder (c.f., Japanese Patent laid-open No. 2022-045464).

According to the teachings of Japanese Patent laid-open No. 2022-045464, a metal as aluminum alloy whose softness is comparable with clay is extruded continuously to be shaped into a product at a bearing section, and a pattern is applied to outer surfaces of a pair of opposing side walls of the product by a pair of rotary tools rotating with extrusion of the metal.

For example, the patterned hollow product produced by the above-explained procedures may be adopted as a louver and a column of a fence. By applying a pattern on the surface of the product, the product may be ornamented, and in addition, some indication may be indicated by the surface pattern.

However, although a pattern may be applied to the outer surfaces of one of pairs of the opposing side walls of the product by the teachings of Japanese Patent laid-open No. 2022-045464, the pattern may not be applied simultaneously to outer surfaces of the other pair of the opposing side walls.

In order to further ornament the hollow product and to enhance the indicating function, it is desirable to apply the surface pattern to the outer surfaces of the other pair of the opposing side walls.

The present invention provides an extrusion die assembly for applying desired patterns simultaneously to outer surfaces of a plurality of pairs of side walls of a hollow body.

### SUMMARY

According to the present invention, there is provided an extrusion die for forming a patterned product that applies a pattern to a plurality of surfaces of a hollow intermediate product formed of thermoplastic material extruded continuously from a feeder, comprising: an upper die to which the thermoplastic material is supplied, and which has a mandrel having a bearing to form a hollow space in the intermediate product; an intermediate die having a bearing to shrink external dimensions of the intermediate product; and a lower die supporting the upper die through the intermediate die. The lower die comprises a first lower die and a second lower die. The first lower die comprises: a first patterning tool that is rotated by a movement of the intermediate product to apply the pattern to at least one of outer surfaces of one of pairs of opposing side walls of the intermediate product; and a second patterning tool that is rotated by the movement of the intermediate product to apply the pattern to at least one of outer surfaces of another pair of the opposing side walls of the intermediate product. The second lower die is joined to the first lower die so as to fix the second patterning tool.

According to the above-explained configuration, therefore, the thermoplastic material passing through a clearance between the bearing formed on the mandrel of the upper die and the bearing formed on the intermediate die is shaped into the hollow intermediate product. Then, the intermediate product passes through the lower die so that the first patterning tool rolls on at least one of the outer surfaces of one of the pairs of opposing side walls of the intermediate product to apply the pattern thereto, and that the second patterning tool rolls on at least one of the outer surfaces of another pair of opposing side walls of the intermediate product to apply the pattern thereto.

According to the present invention, the first lower die of the lower die may further comprise the lower guard surface that guides the intermediate product formed by the bearings, and the mandrel may comprise the retreating surface that absorbs the pressing forces applied to the intermediate product from the first patterning tool and the second patterning tool.

According to the above-explained configuration, therefore, the pressing forces applied to the intermediate product from the first patterning tool and the second patterning tool may be absorbed by a clearance between the intermediate product and the retreating surface.

According to the present invention, the mandrel may extend to the level lower than the levels at which the first patterning tool and the second patterning tool roll on the intermediate product in the moving direction of the intermediate product, and the retreating surface may expand to the leading end of the mandrel.

According to the above-explained configuration, therefore, the thermoplastic material flown by the pressing forces of the first patterning tools and the second patterning tool in the downstream side of the intermediate product toward the hollow space may be received by the retreating surface.

According to the present invention, the first patterning tool and the second patterning tool may be adapted to apply the same pattern to the outer surfaces of the intermediate product. In addition, the first patterning tool and the second patterning tool may include a tool adapted to form a plane surface on the side wall of the intermediate product, and tools adapted to apply different patterns to the outer surfaces of the intermediate product.

According to the above-explained configuration, therefore, the pattern applied to the outer surfaces of the hollow intermediate product may be selected arbitrarily from a plurality of patterns. In addition, the plane surface may also be formed on the outer surface of the hollow intermediate product.

In addition, according to the present invention, the first patterning tool and the second patterning tool may be held in the first lower die in a rotatable manner, and the positions of the first patterning tool and the second patterning tool with respect to the intermediate product may be adjusted individually in the first lower die. For these purposes, the bearing may be fitted on each end of shafts of the first patterning tool and the second patterning tool. A first plug may be mounted on each of the bearings fitted on each end of the shaft of the first patterning tool, and a second plug may be mounted on each of the bearings fitted on each end of the shaft of the second patterning tool. Each of the first plugs may be fitted individually into the first recess formed on the upper surface of the first lower die, and each of the second plug may be individually fitted into the second recess formed on the lower surface of the first lower die. In addition, the first lower die may further comprise the binding force adjusting mechanism that adjust the binding force applied to each of the first patterning tool and the second patterning tool so as to allow the first patterning tool and the second patterning tool to slide toward and away from the intermediate product.

According to the above-explained configuration, therefore, the pressing forces applied to the intermediate product from the first patterning tool and the second patterning tool may be adjusted by adjusting the positions of the first patterning tool and the second patterning tool with respect to the intermediate product. That is, depths of the pattern to be applied to the intermediate product by the first patterning tool and the second patterning tool may be adjusted. To this end, both ends of the first patterning tool are supported by the first plugs fitted into the first recess formed on the upper surface of the first lower die, and a position of the first patterning tool with respect to the intermediate product are adjusted by loosening the binding force adjusting mechanism. Likewise, both ends of the second patterning tool are supported by the second plugs fitted into the second recess formed on the lower surface of the first lower die, and a position of the second patterning tool with respect to the intermediate product are adjusted by loosening the binding force adjusting mechanism. Thus, the first patterning tool and the second patterning tool may be fitted easily into the lower die, and the positions of the first patterning tool and the second patterning tool with respect to the intermediate product may be adjusted easily.

### BRIEF DESCRIPTION OF THE DRAWINGS

FIG. 1 is a perspective view showing details of the extrusion die for forming a patterned product according to the present invention.

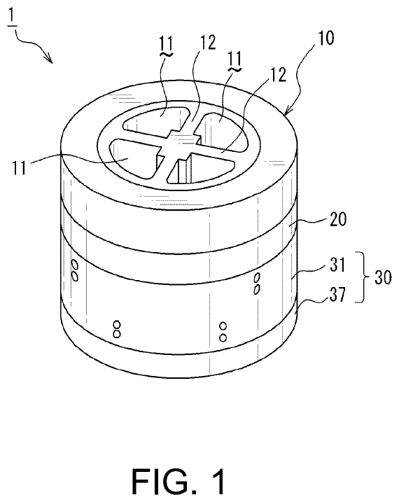

FIG. 2 (a) is a perspective view showing an upper die according to the present invention, and (b) is an enlarged cross-sectional view of the upper die.

FIG. 3 (a) is a perspective view showing an intermediate die according to the present invention, and (b) is an enlarged cross-sectional view of the intermediate die.

FIG. 4 (a) is a perspective view showing a first lower die of a lower die according to the present invention viewed from above, (b) is a perspective view showing the first lower die viewed from below, and (c) is a perspective view showing the first lower die combined with a second lower die.

FIG. 4A is an exploded cross-sectional view showing cross-sections of the first lower die, the second lower die, and connection bolts.

FIG. 5 is a plan view showing the lower die holding patterning tools according to the present invention.

FIG. 6 is a bottom plan view of the lower die holding the patterning tools.

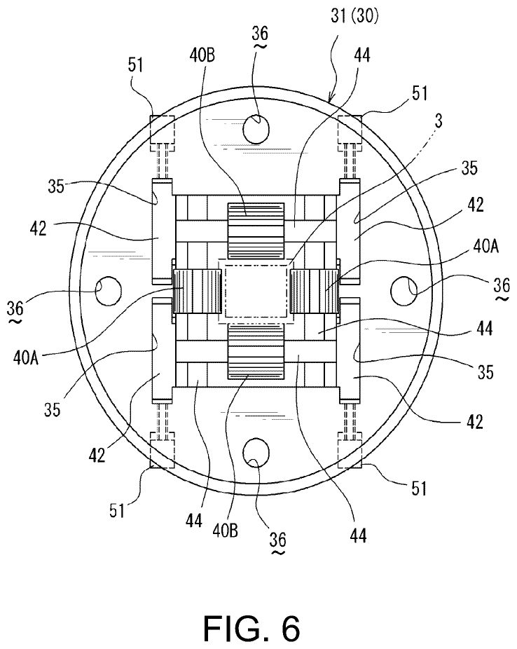

FIG. 7 is a perspective cross-sectional view showing an installation structure of the first patterning tool.

FIG. 8 is a cross-sectional view along the I-I line drawn in FIG. 5.

FIG. 8A is a cross-sectional view along the II-II line drawn in FIG. 8.

FIG. 9 is an enlarged cross-sectional view of a main part of FIG. 8.

FIG. 9A is an enlarged cross-sectional view of a main part of FIG. 8A.

FIG. 10 (a) is a perspective cross-sectional view showing the first patterning tool fitted with the first lower die, and (b) is a perspective cross-sectional view showing a second forming tool fitted with the first lower die.

FIG. 11A is an exploded perspective view showing a first plug of the first patterning tool dismounted from the first lower die.

FIG. 11B is an exploded perspective view showing a second plug of the second patterning tool dismounted from the first lower die.

FIG. 12 is a partial cross-sectional view showing a binding force adjusting mechanism according to the present invention, in which (a) shows a situation where the patterning tool comes closest to an intermediate product, and (b) shows a situation where the patterning tool slightly comes close to the intermediate product.

FIG. 13 is a cross-sectional view along the III-III line drawn in FIG. 12 (b).

FIG. 14A (a) is an upper perspective view of a product in which a same pattern is applied to outer surfaces, and (b) is a lower perspective view of the above-mentioned product.

FIG. 14B (a) is an upper perspective view of a product in which a same pattern is applied to three outer surfaces by the patterning tools and the remaining surface is maintained to a plane surface, and (b) is a lower perspective view of the above-mentioned product.

FIG. 14C (a) is an upper perspective view of a product in which a same pattern is applied to two outer surfaces by the patterning tools and the remaining surfaces are maintained to plane surfaces, and (b) is a lower perspective view of the above-mentioned product.

FIG. 15 (a) is an upper perspective view of a product in which an uneven pattern is applied to the outer surfaces of a pair of opposing side walls by one of the pairs of the patterning tools and a rectangular pattern is applied to outer surfaces of another pair of opposing side walls by another pair of the patterning tools, and (b) is a lower perspective view of the above-mentioned product.

FIG. 16 (a) is an upper perspective view of a product in which the uneven pattern is applied to the outer surfaces of a pair of opposing side walls by one of the pairs of the patterning tools and a rectangular pattern and a square pattern are applied to outer surfaces of another pair of opposing side walls by another pair of the patterning tools, and (b) is a lower perspective view of the above-mentioned product.

### DESCRIPTION OF THE EMBODIMENTS

According to a first aspect of the present invention, after the thermoplastic material is shaped into the hollow intermediate product, the first patterning tool may roll on at least one of the outer surfaces of one of the pairs of opposing side walls of the intermediate product to apply the pattern thereto, and then the second patterning tool may roll on at least one of the outer surfaces of another pair of opposing side walls of the intermediate product to apply the pattern thereto. Thus, desired pattern may be applied to the outer surface of the intermediate product consecutively.

According to a second aspect of the invention of the present invention, the pressing forces applied to the intermediate product from the first patterning tool and the second patterning tool may be absorbed by the clearance between the intermediate product and the retreating surface, and the inner surface of the intermediate product may be pushed onto the retreating surface by the pressing forces applied thereto. Therefore, the inner surface of the intermediate product will not be deformed into a wavy shape.

According to a third aspect of the invention of the present invention, the thermoplastic material flown by the pressing forces of the first patterning tools and the second patterning tool in the downstream side of the intermediate product toward the hollow space may be received by the retreating surface. Therefore, the inner surface of the intermediate product may be pushed tightly onto the retreating surface so that the inner surface of the intermediate product is prevented from being deformed into a wavy shape.

According to a fourth, a fifth, and a sixth aspect of the present invention, a pair of the first patterning tools and a pair of the second patterning tools may be formed by combining the patterning tools for applying a same pattern to the outer surfaces of the intermediate product. Instead, a pair of the first patterning tools and a pair of the second patterning tools may also be formed by combining the patterning tools for applying different patterns to the outer surfaces of the intermediate product including the patterning tool for forming the plane surface. Therefore, the patterns to be applied to the outer surfaces of the hollow intermediate product may be selected arbitrarily from a plurality of patterns. In addition, the plane surface may also be formed on the outer surface of the hollow intermediate product.

According to a seventh and an eighth aspect of the present invention, the positions of the first patterning tools and the second patterning tools with respect to the intermediate product may be adjusted individually in the first lower die. Therefore, the pressing forces applied to the intermediate product from the first patterning tools and the second patterning tools may be adjusted by adjusting the positions of the first patterning tools and the second patterning tools with respect to the intermediate product. That is, depths of the pattern to be applied to the intermediate product by the first patterning tools and the second patterning tools may be adjusted arbitrarily. In addition, according to the eighth aspect of the present invention, the first patterning tools and the second patterning tools may be fitted easily into the lower die.

Hereinafter, embodiments of the present invention will be described in detail with reference to the accompanying drawings.

An extrusion die 1 for forming a patterned product (hereinafter simply referred to as the extrusion die 1) comprises: an upper die 10 to which a thermoplastic material (metal M) extruded from a container 2 as a feeder is introduced, and which has a mandrel 13 including an inner bearing 15 for forming a hollow space in the thermoplastic material; an intermediate die 20 including an outer bearing 25; and a lower die 30 supporting the upper die 10 through the intermediate die 20.

The lower die 30 comprises a first lower die 31 and a second lower die 37. The first lower die 31 comprises: a pair of first patterning tools 40A rotated by a movement of an intermediate product 3 to apply a pattern Da to outer surfaces of a pair of opposing side walls of the intermediate product 3; and a pair of second patterning tools 40B also rotated by the movement of the intermediate product 3 to apply the pattern Da to outer surfaces of the other pair of opposing side walls of the intermediate product 3. The second lower die 37 is joined to the first lower die 31 so as to fix the second patterning tools 40B.

Specifically, an annular recess 10a is formed on an outer circumference of a lower surface of the upper die 10, and an annular protrusion 20b is formed on an outer circumference of an upper surface of the intermediate die 20 so that the upper die 10 and the intermediate die 20 are joined together by engaging the annular protrusion 20b of the intermediate die 20 with the annular recess 10a of the upper die 10. Likewise, an annular recess 20a is formed on an outer circumference of a lower surface of the intermediate die 20, and an annular protrusion 31b is formed on an outer circumference of an upper surface of the first lower die 31 of the lower die 30 so that the intermediate die 20 and the first lower die 31 are joined together by engaging the annular protrusion 31b of the first lower die 31 with the annular recess 20a of the intermediate die 20. The upper die 10, the intermediate die 20, and the first lower die 31 are fastened by a connection bolt (not shown) inserted into those members from a lower surface of the first lower die 31. Consequently, the intermediate die 20 is clamped by the upper die 10 and the first lower die 31 so that the intermediate die 20 is prevented from being deformed and warped.

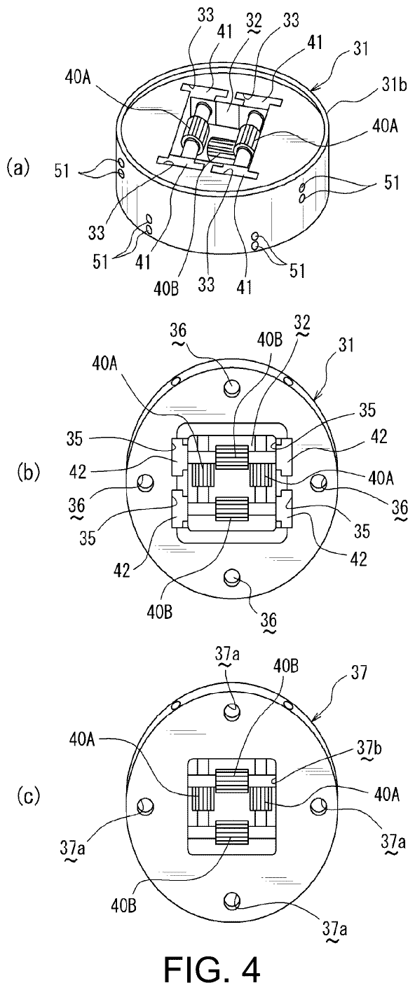

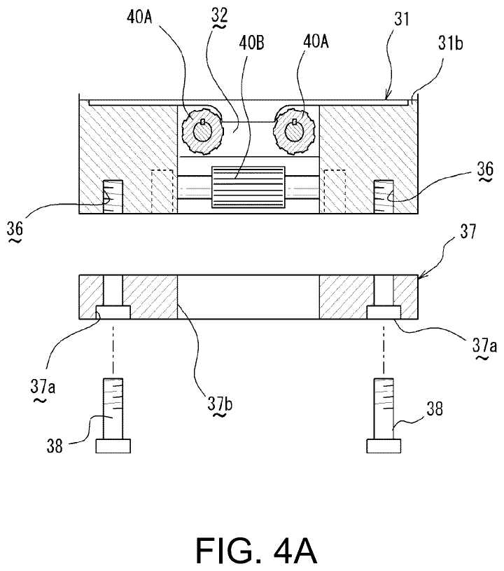

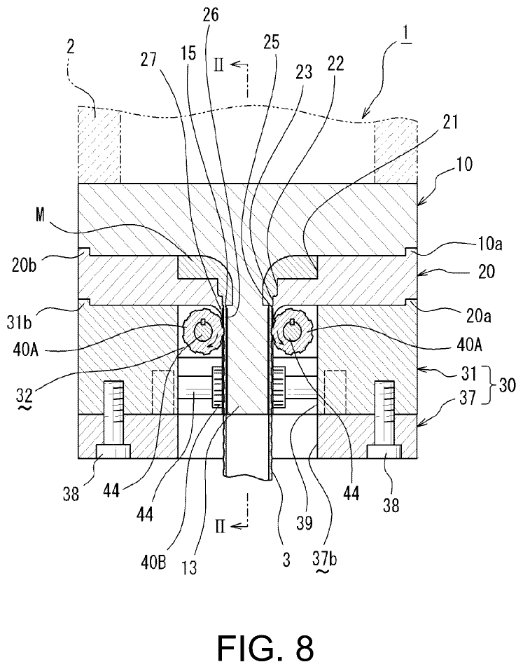

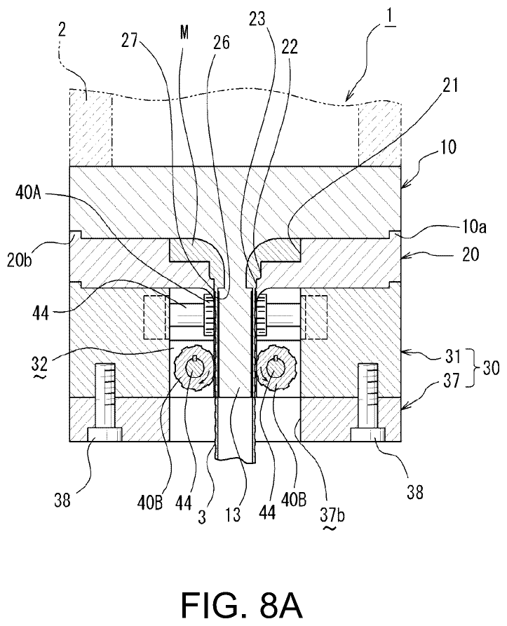

In the lower die 30, four screw holes 37a are formed on the second lower die 37 and four screw holes 36 are formed on the first lower die 31 so that the second lower die 37 is fastened to the first lower die 31 by screwing a bolt 38 into each of the screw holes 36 of the first lower die 31 through the screw holes 37a of the second lower die 37 (cf., FIGS. 4A, 8, and 8A).

As illustrated in FIGS. 8 and 8A, the container 2 is laid on an upper surface of the upper die 10. The metal M is held in the container 2, and the container 2 is adapted to maintain a temperature of the metal M within a range from 400 degrees C. to 500 degrees C.

In order to place the container 2 on the upper die 10, a shallow circular dent is formed at the center of the upper surface of the upper die 10, and in order to introduce the metal M, four sectorial inlet holes 11 are formed in the circular dent equiangularly around a center axis of the upper die 10. Specifically, the inlet holes 11 are defined by bridges 12 intersecting one another. In other words, each portion between the inlet holes 11 individually serves as the bridge 12.

A mandrel 13 is sustained by the bridges 12. Specifically, a support shaft 14 extends downwardly in the axial direction of the upper die 10 from the center of the lower surface of the upper die 10 (i.e., at the intersection between the bridges 12), and the mandrel 13 further extends downwardly from a leading end of the support shaft 14.

Specifically, the mandrel 13 extends to a level at which a leading end surface thereof is situated lower than the outer bearing 25 of the intermediate die 20 and rotational center axes of the second patterning tools 40B arranged in the first lower die 31 of the lower die 30. That is, the mandrel 13 extends to a level at which the leading end surface thereof is situated downstream of a level at which the second patterning tools 40B roll on the intermediate product 3 in the moving direction of the intermediate product 3 (cf., FIGS. 8 and 8A).

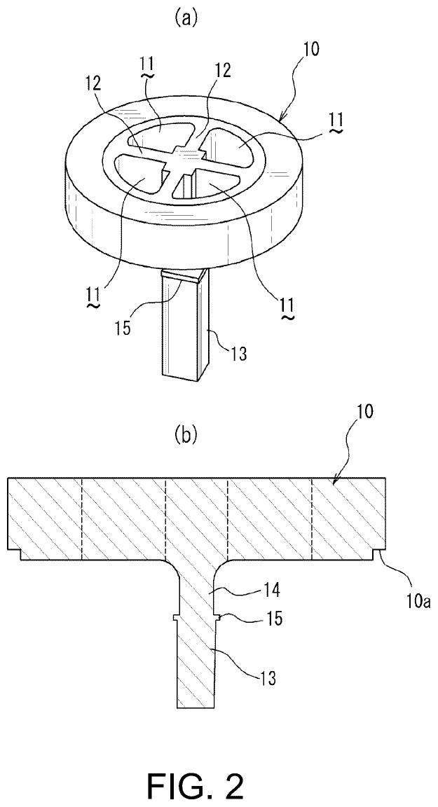

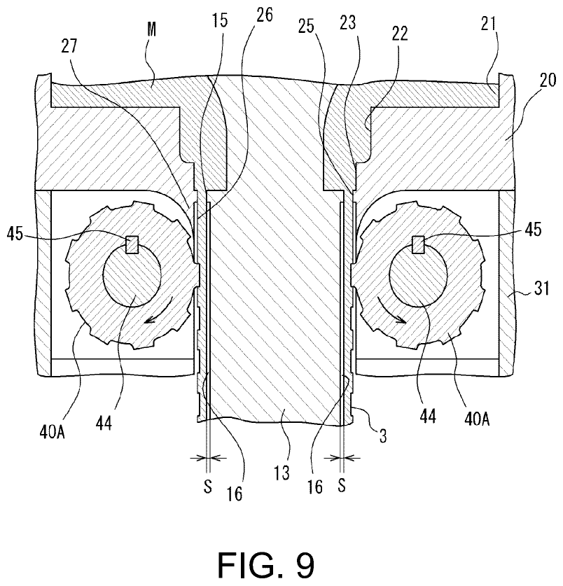

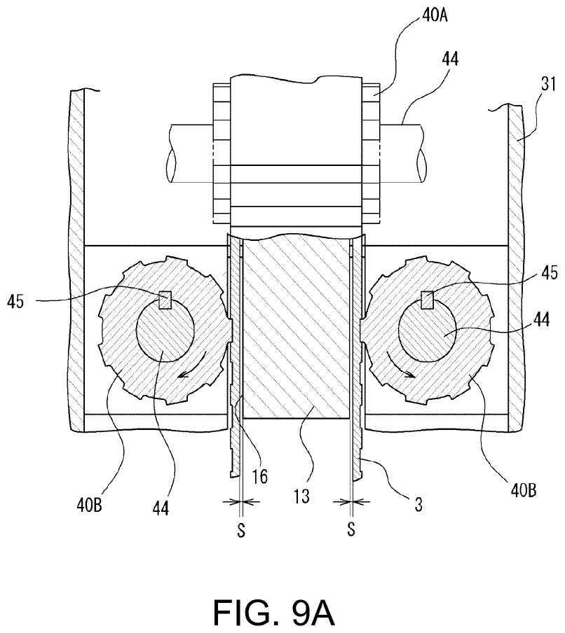

As illustrated in FIG. 2 (b), the inner bearing 15 is formed above the mandrel 13. Specifically, dimensions of the inner bearing 15 are substantially congruent with internal dimensions of a product 4. That is, the inner bearing 15 has a square (or rectangular) cross-sectional shape. In order to prevent deformation of the inner surfaces of the intermediate product when rolling the first patterning tools 40A and the second patterning tools 40B on the outer surfaces of the intermediate product 3, outer surfaces of the mandrel 13 opposing to the inner surfaces of the intermediate product 3 are retreated respectively. Specifically, each of the outer surfaces of the mandrel 13 between the inner bearing 15 and the leading end of the mandrel 13 individually serves as the retreating surface 16 (cf., FIG. 9).

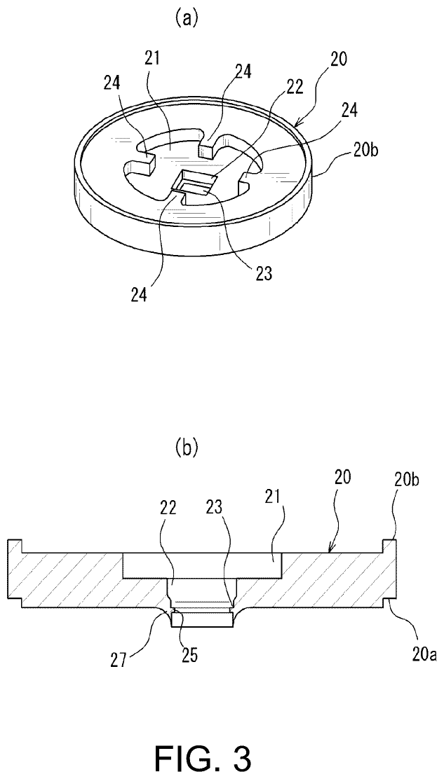

As illustrated in FIG. 3, in order to place the upper die 10 on the intermediate die 20, a shallow circular dent is formed at the center of the upper surface of the intermediate die 20. The circular dent is further depressed to form a first reservoir 21 having a contour similar to contours of the inlet holes 11, and the metal M introduced from the inlet holes 11 is temporarily held in the first reservoir 21. The metal M is further progressed from the first reservoir 21 to be shaped into the product 4 as a hollow square (or rectangular) column. In the first reservoir 21, four projections 24 protrude equiangularly from an inner circumferential surface of the first reservoir 21 toward the center axis of the intermediate die 20 so that bottom surfaces of radially outer portions of the bridges 12 are supported by the projections 24. Therefore, the bridges 12 will not be warped by a friction (or resistance) acting between the metal M and the mandrel 13. That is, the projections 24 are formed to enhance bending stiffness of the bridges 12.

A central portion of the first reservoir 21 is further depressed to form a second reservoir 22. Specifically, an opening area of the second reservoir 22 is larger than external dimensions of the product 4, and the second reservoir 22 is tapered downwardly. The second reservoir 22 is further depressed to form a third reservoir 23 whose opening area is smaller than the opening area of the second reservoir 22. Therefore, the external dimensions of the metal M are shrunk gradually with the progress of the metal M through the first reservoir 21, the second reservoir 22, and the third reservoir 23.

The outer bearing 25 is formed downstream of the third reservoir 23. Specifically, the outer bearing 25 is opposed to the inner bearing 15 of the mandrel 13, and an opening area of the outer bearing 25 is smaller than the opening area of the third reservoir 23. That is, the external dimensions of the metal M are further shrunk by the outer bearing 25 to designed external dimensions of the product 4. To this end, dimensions of an opening edge of the outer bearing 25 are set to the designed external dimensions of the product 4. As described, the dimensions of the inner bearing 15 are substantially congruent with the internal dimensions of a product 4, therefore, a thickness the metal M is reduced to a designed thickness of the product 4 as a result of passing through a clearance between the inner bearing 15 and the outer bearing 25 except for the pattern Da.

In order to guide the metal M extruded from the clearance between the inner bearing 15 and the outer bearing 25 (that is, the metal M shaped into the intermediate product 3) to the lower die 30, an upper guard surface 26 extends downwardly from the outer bearing 25.

Specifically, a portion of the lower surface of the intermediate die 20 below the outer bearing 25 is rounded downwardly along the first patterning tool 40A to form a protrusion 27. In other words, the protrusion 27 protrudes downwardly above a portion of an outer circumference of the first patterning tool 40A. That is, a surface of the protrusion 27 facing the intermediate product 3 serves as the upper guard surface 26, and a predetermined clearance is maintained between the upper guard surface 26 and the intermediate product 3. In addition, a portion of the retreating surface 16 below the protrusion 27 is slightly inclined thereby increasing a clearance between the intermediate product 3 and the retreating surface 16.

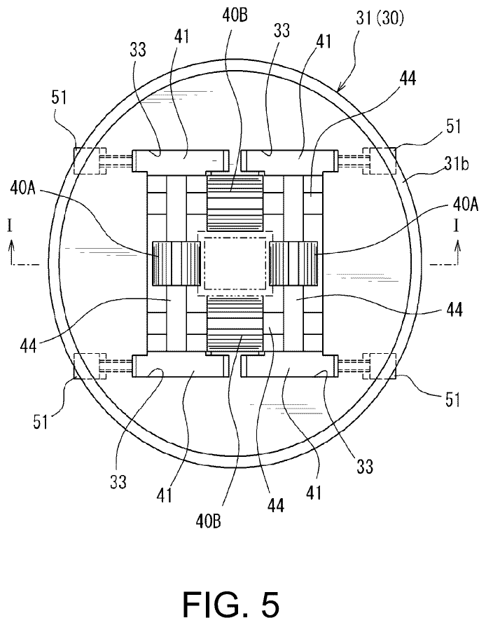

As illustrated in FIGS. 4, 4A, and 5, the first lower die 31 of the lower die 30 is a cylindrical member, and the annular protrusion 31b that is engaged with the annular recess 20a of the intermediate die 20 is formed on the circumference of an upper surface of the first lower die 31. In the first lower die 31, a patterning tool holding space (hereinafter simply referred to as the holding space) 32 for holding the first patterning tools 40A and the second patterning tools 40B is formed in the central area of a circular portion. Specifically, the holding space 32 is a rectangular space whose transverse section is rectangle.

In the first lower die 31, inner surfaces of the holding space 32 serves as lower guard surfaces 39 for guiding the intermediate product 3. Specifically, inner surfaces of the holding space 32 formed between the upper surface and the lower surface of the first lower die 31 serve as the lower guard surfaces 39. That is, the lower guard surfaces 39 are formed in the axial direction of the first lower die 31. As illustrated in FIGS. 8 and 8A, an opening area enclosed by the lower guard surfaces 39 is larger than an opening area enclosed by the upper guard surfaces 26. Likewise, an opening 37b having same dimensions as the opening enclosed by the lower guard surfaces 39 is formed in the second lower die 37 joined to the first lower die 31.

In the holding space 32 of the first lower die 31, a pair of the first patterning tools 40A for applying the pattern Da to the outer surfaces of the pair of the opposing side walls of the intermediate product 3 is held in an upper space below the intermediate die 20, and a pair of the second patterning tools 40B for applying the pattern Da to the outer surfaces of another pair of opposing side walls of the intermediate product 3 is held in a lower space (or bottom side).

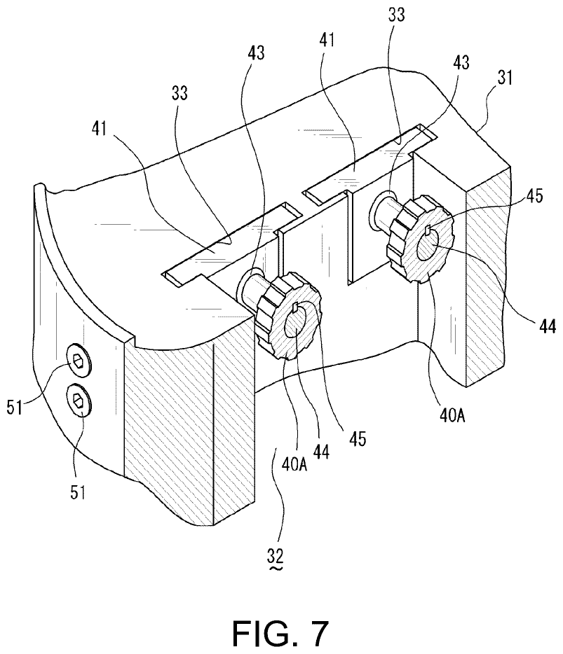

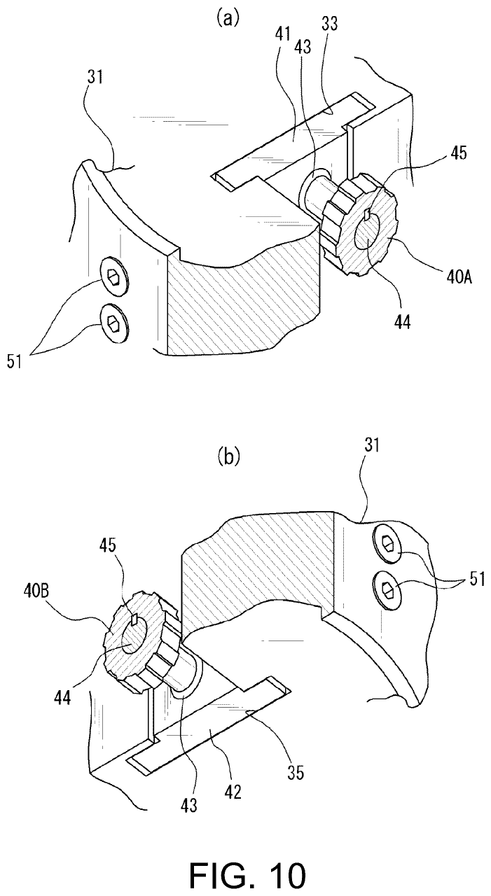

Specifically, on the upper surface of the first lower die 31, a pair of mounting recesses (hereinafter referred to as the first recess) 33 is formed along each side of one of pairs of opposing sides of the holding space 32, and installation plugs (hereinafter referred to as the first plug) 41 mounted on both ends of a shaft 44 of the first patterning tool 40A are held in the first recesses 33 respectively. The first recess(es) 33 formed on said one side of the holding space 32 is/are illustrated in FIGS. 7 and 10 (a). As illustrated in FIGS. 7 and 10 (a), the first recess 33 is a rectangular hole having a predetermined width and depth, and the first plug 41 is inserted into the first recess 33.

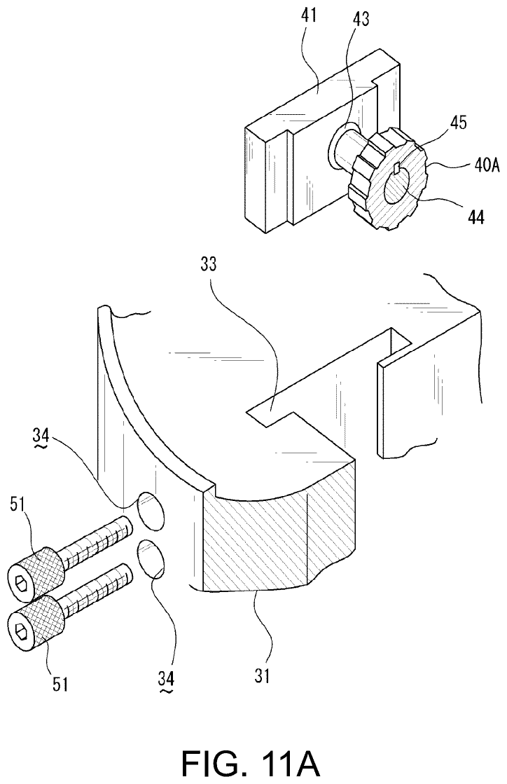

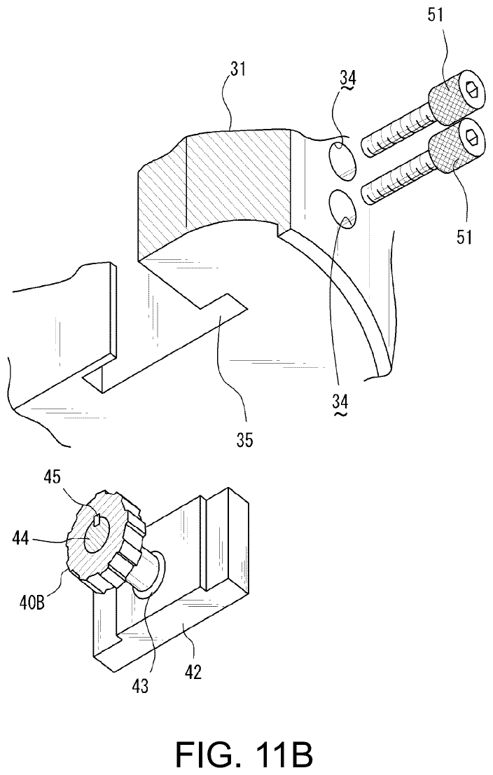

As illustrated in FIGS. 10 (a) and 11A, a pair of screw holes 34 is formed on an outer circumferential surface of the first lower die 31 at each portion of radially outer side of the first recess 33. In the pair of screw holes 34, specifically, one of the screw holes 34 is formed on an upper side of the outer circumferential surface of the first lower die 31, and the other one of the screw holes 34 is formed on a lower side of the outer circumferential surface of the first lower die 31. Each of the screw holes 34 individually penetrates through the first lower die 31 from the outer circumferential surface of the first lower die 31 to the first recess 33. An inner diameter of the screw hole 34 at a portion close to the first recess 33 is smaller than that at a portion close to the outer circumferential surface of the first lower die 31, and a female thread 34a is formed on an inner surface of the portion of the screw hole 34 in which the inner diameter is smaller. An adjuster bolt 51 of an after-mentioned binding force adjusting mechanism is screwed into each of the screw holes 34.

Likewise, on the lower (or bottom) surface of the first lower die 31, a pair of mounting recesses (hereinafter referred to as the second recess) 35 is formed along each side of the other pair of opposing sides of the holding space 32 as illustrated in FIG. 10 (b), and installation plugs (hereinafter referred to as the second plug) 42 mounted on both ends of the shaft 44 of the second patterning tool 40B are held in the second recesses 35 respectively. As the first recess 33, the second recess 35 is a rectangular hole having a predetermined width and depth, and the second plug 42 is inserted into the second recess 35.

As illustrated in FIGS. 10 (b) and 11B, a pair of the screw holes 34 is also formed on the outer circumferential surface of the first lower die 31 at each portion of radially outer side of the second recess 35. In the pair of screw holes 34, specifically, one of the screw holes 34 is formed on the upper side of the outer circumferential surface of the first lower die 31, and the other one of the screw holes 34 is formed on the lower side of the outer circumferential surface of the first lower die 31. Each of the screw holes 34 penetrates through the first lower die 31 from the outer circumferential surface of the first lower die 31 to the second recess 35. An inner diameter of the screw hole 34 at a portion close to the second recess 35 is smaller than that at the portion close to the outer circumferential surface of the first lower die 31, and the female thread 34a is formed on the inner surface of the portion of the screw hole 34 in which the inner diameter is smaller. The adjuster bolt 51 of the binding force adjusting mechanism is screwed into each of the screw holes 34.

In order to form the pattern Da on the outer surfaces of the hollow intermediate product 3 consecutively in the longitudinal direction, a patterning roller is adopted as the first patterning tools 40A and the second patterning tools 40B, respectively. In the patterning roller, a set of teeth is formed on an outer circumference at predetermined intervals. For example, the first patterning tools 40A may be adapted to apply the pattern Da to the outer surfaces of the narrower side walls of the intermediate product 3, and the second patterning tools 40B may be adapted to apply the pattern Da to the outer surfaces of the wider side walls of the intermediate product 3. For these purposes, face widths of the teeth of the first patterning tool 40A and the second patterning tool 40B are set to different widths, but remaining structures of the first patterning tool 40A and the second patterning tool 40B are similar to each other. As described, the first patterning tools 40A roll on the outer surfaces of the narrower side walls of the intermediate product 3 and the second patterning tools 40B roll on the outer surfaces of the wider side walls of the intermediate product 3 with the downward movement of an intermediate product 3. Consequently, the pattern Da including transvers depressions Da1 and transverse projections Da2 juxtaposed alternately is applied to the outer surfaces of the side walls of the intermediate product 3.

Here will be explained a structure of the first patterning tool 40A in more detail with reference to FIG. 9. As illustrated in FIG. 9, a clearance S is maintained between the retreating surface 16 of the mandrel 13 and the inner surface of the intermediate product 3 given that the intermediate product 3 progresses downwardly without being subjected to a load from the first patterning tool 40A. Therefore, a pressing force applied to the outer surface of the intermediate product 3 from the teeth of the first patterning tool 40A is absorbed by the clearance S when the first patterning tool 40A rolls on the outer surface of the intermediate product 3 to apply the pattern Da thereto. Consequently, the inner surface of the intermediate product 3 is pushed onto the retreating surface 16. In this situation, since the inner surface of the intermediate product 3 is pushed tightly onto the retreating surface 16, the inner surface of the intermediate product 3 will not be deformed into a wavy shape.

As the case of applying the pattern Da to the outer surface of the intermediate product 3 by the first patterning tool 40A, the inner surface of the intermediate product 3 is also pushed onto the retreating surface 16 by the second patterning tool 40B rolling on the outer surface of the intermediate product 3 to apply the pattern Da to the outer surface of the intermediate product 3. Therefore, the inner surface of the intermediate product 3 will also not be deformed into a wavy shape by the second patterning tool 40B.

Next, here will be explained installation structures of the first patterning tools 40A and the second patterning tools 40B. In the descriptions, common reference numerals are allotted to common structures. As described, each of the first patterning tools 40A (and the second patterning tools 40B) is individually opposed to the retreating surface 16. As illustrated in FIGS. 10, 11A, and 11B, a bearing 43 is fitted on each end of the shaft 44 of the first patterning tools 40A (and the second patterning tools 40B), and the first plugs 41 (and the second plug 42) are mounted on the bearings 43 respectively. As illustrated in FIGS. 10 to 12, each of the first plugs 41 is fitted into the first recess 33 (and each of the second plugs 42 is fitted into the second recess 35) while being allowed to slide toward and away from the intermediate product 3 (or the metal M). Specifically, each of the first patterning tools 40A (and the second patterning tools 40B) is fitted onto the shaft 44 through a key 45.

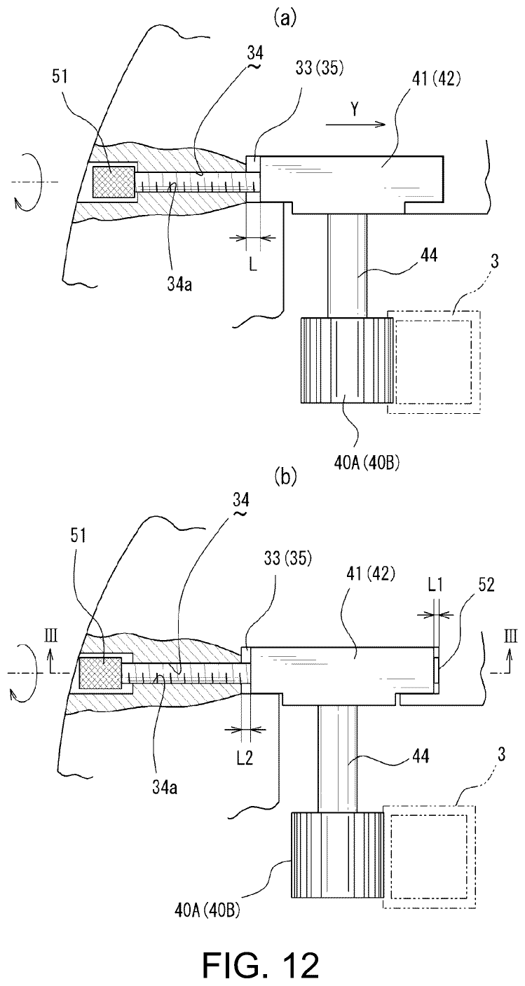

Next, here will be explained a structure of the binding force adjusting mechanism with reference to FIG. 12. The binding force adjusting mechanism comprises: the adjuster bolt 51 that is brought into contact with an outer side wall of the first plug 41 (or the second plug 42); and a positioning spacer 52 interposed between an inner side wall of the first plug 41 (or the second plug 42) and an inner side wall of the first recess 33 (or the second recess 35) in a detachable manner.

Specifically, the adjuster bolt 51 is screwed into the screw hole 34 formed on the outer circumferential surface of the first lower die 31 while being mated with the female thread 34a formed on the inner surface of the screw hole 34 so that a leading end of the adjuster bolt 51 is brought into contact with the outer side wall of the first plug 41 (or the second plug 42).

As illustrated in FIG. 12 (a), the first plug 41 (or the second plug 42) is displaced within the first recess 33 (or the second recess 35) in the direction indicated by the arrow Y by screwing the adjuster bolt 51 into the screw hole 34. Consequently, a distance between the teeth of the first patterning tool 40A (or the second patterning tool 40B) and the outer surface of the intermediate product 3, that is, a depth of the transverse depressions Da1 to be formed by the teeth of the first patterning tool 40A (or the second patterning tool 40B) is adjusted. Specifically, FIG. 12 (a) shows a situation in which the adjuster bolt 51 is screwed into the screw hole 34 to the maximum. In this situation, the inner side wall of the first plug 41 (or the second plug 42) is brought into contact with the inner side wall of the first recess 33 (or the second recess 35), and a predetermined clearance L is created between the outer side wall of the first plug 41 (or the second plug 42) and an outer side wall of the first recess 33 (or the second recess 35).

FIG. 12 (b) shows a situation in which a position of the first patterning tool 40A (or the second patterning tool 40B) is adjusted to reduce a depth of the transverse depressions Da1. To this end, the first plug 41 (or the second plug 42) is allowed to slide in the first recess 33 (or the second recess 35) by turning the adjuster bolt 51 e.g., counterclockwise. In this case, therefore, the adjuster bolt 51 is turned counterclockwise until the clearance L is eliminated.

Then, the first patterning tool 40A (or the second patterning tool 40B) is moved toward the adjuster bolt 51 by hand. In this situation, the positioning spacer 52 is inserted into a clearance L1 between the inner side wall of the first plug 41 (or the second plug 42) and the inner side wall of the first recess 33 (or the second recess 35) so as to fix the position of the first patterning tool 40A (or the second patterning tool 40B) to a position at which a depth of the transverse depressions Da1 is adjusted to a desired depth. Thereafter, the adjuster bolt 51 is turned e.g., clockwise until the leading end of the adjuster bolt 51 comes into contact with the outer side wall of the first plug 41 (or the second plug 42). In this case, a total clearance of: the clearance L1 between the inner side wall of the first plug 41 (or the second plug 42) and the inner side wall of the first recess 33 (or the second recess 35); and a clearance L2 between the outer side wall of the first plug 41 (or the second plug 42) and the outer side wall of the first recess 33 (or the second recess 35), is equal to the clearance L shown in FIG. 12 (a) (as expressed as L=L1+L2).

The binding force applied to the patterning tool may be adjusted by turning only one of the adjuster bolts 51. That is, the number of adjuster bolt 51 arranged on radially outer side of the each of the recesses may be reduced to one.

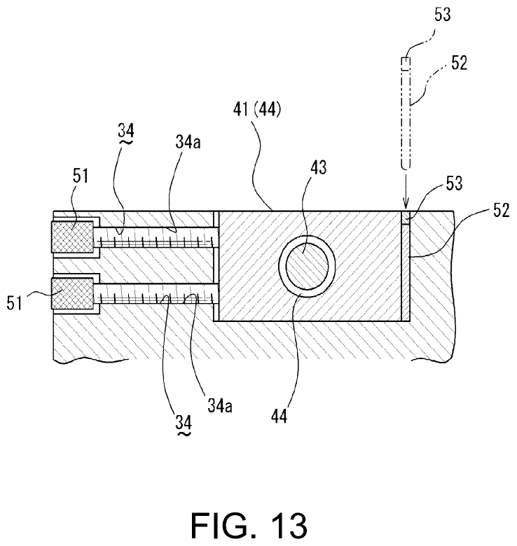

As illustrated in FIG. 13, the positioning spacer 52 is a plate member having a predetermined thickness. In order to adjust a position of the first patterning tool 40A (or the second patterning tool 40B) to a plurality of positions to vary a depth of the transverse depressions Da1, the positioning spacer 52 may be selected from a plurality of the positioning spacer 52 having different thicknesses. Specifically, a width of the positioning spacer 52 is substantially identical to a thickness of the first plug 41 (or the second plug 42).

As illustrated in FIG. 13, a knob 53 is formed on each upper corner of the positioning spacer 52 so that the positioning spacer 52 may be inserted into the clearance L1 by clamping the knobs 53 by a dedicated clamping tool (or jig).

Next, here will be explained a forming method of the product 4 using the extrusion diel having the foregoing structures. First of all, the first patterning tools 40A and the second patterning tools 40B for applying the pattern Da to the surfaces of the intermediate product 3 are set in the lower die 30 in advance.

Specifically, the first plugs 41 of the first patterning tools 40A are inserted into the first recesses 33 formed on the upper surface of the first lower die 31 (facing the intermediate die). Likewise, the second plugs 42 of the second patterning tools 40B are inserted into the second recesses 35 formed on the lower (or bottom) surface of the first lower die 31. On this occasion, in order to adjust a depth of the transverse depressions Da1 to a desired depth, in other words, to adjust a height of the transverse projections Da2 to a desired height, positions of the first patterning tools 40A and the second patterning tools 40B are adjusted by turning the adjuster bolts 51.

After setting the first patterning tools 40A in the lower die 30, the upper die 10, the intermediate die 20, and the first lower die 31 are fastened together by screwing connection bolts (not shown) from the bottom surface of the first lower die 31. Then, after setting the second patterning tools 40B, the second lower die 37 is fastened to the first lower die 31 by screwing the bolt 38 into each of the four screw holes 36 formed on the first lower die 31 through each of the four screw holes 37a formed on the second lower die 37 (cf., FIGS. 4A, 8, and 8A).

After setting the first patterning tools 40A and the second patterning tools 40B in the lower die 30, the metal M is fed from the container 2 to the upper die 10. Consequently, the metal M is extruded from the inlet holes 11 toward the downstream side through the first to third reservoirs 21, 22, and 23. Eventually, the metal M passes through the clearance between the inner bearing 15 formed above the mandrel 13 of the upper die 10 and the outer bearing 25 formed below the third reservoir 23 of the intermediate die 20. Consequently, the metal M is shaped into the intermediate product 3 having a hollow structure, and the intermediate product 3 is further extruded along the upper guard surface 26 toward the lower die 30. As described, the protrusion 27 protrudes downwardly from the intermediate die 20 above the first patterning tool 40A. Therefore, the leading end of the metal M extruded from the third reservoir 23 will not come into contact with the first patterning tools 40A before entering into the clearance between the first patterning tools 40A and the mandrel 13. For this reason, the pressing force may be applied to intended sites of the intermediate product 3 by the first patterning tools 40A.

When the intermediate product 3 passes through the holding space 32 of the lower die 30, the pair of the first patterning tools 40A roll on the outer surfaces of the narrower side walls of the intermediate product 3. That is, the first patterning tools 40A are rotated by a load extruding the metal M into the extrusion die 1. Consequently, the pattern Da is applied sequentially to the outer surfaces of the narrower side walls of the intermediate product 3 by the first patterning tools 40A.

As described, when the first patterning tool 40A rolls on the outer surface of the narrower side wall of the intermediate product 3 extruded from the intermediate die 20, the narrower side wall of the intermediate product 3 is pushed inwardly by the first patterning tool 40A. However, as illustrated in FIG. 9, the clearance S is maintained extensively between the retreating surface 16 of the mandrel 13 facing the first patterning tool 40A and the inner surface of the intermediate product 3. In this situation, therefore, the inner surface of the narrower side wall of the intermediate product 3 is pushed onto the retreating surface 16. That is, the pressing force applied to the narrower side wall of the intermediate product 3 from the first patterning tool 40A is absorbed by the clearance S. In addition, the inner surface of a portion of the intermediate product 3 which has already passed through the first patterning tool 40A is also brought into contact with the retreating surface 16. Therefore, even if the metal M partially flows toward the portion of the intermediate product 3 which has already passed through the first patterning tool 40A, the metal M will not further flow inwardly toward the hollow space of the intermediate product 3 in the portion which has already passed through the first patterning tool 40A. For this reason, the inner surface of the intermediate product 3 may be shaped entirely into a flat surface. In other words, the inner surface of the intermediate product 3 will not be shaped into an uneven surface.

After applying the pattern Da to the outer surfaces of the narrower side walls of the intermediate product 3, the intermediate product 3 further progresses downwardly through the holding space 32 of the lower die 30 so that the pair of the second patterning tools 40B roll on the outer surfaces of the wider side walls of the intermediate product 3. That is, the second patterning tools 40B are also rotated by the load extruding the metal M into the extrusion die 1. Consequently, the pattern Da is also applied sequentially to the outer surfaces of the wider side walls of the intermediate product 3 by the second patterning tools 40B.

When the second patterning tool 40B rolls on the outer surface of the wider side wall of the intermediate product 3 to apply the pattern Da thereto, the wider side wall of the intermediate product 3 is also pushed inwardly by the second patterning tool 40B. However, as illustrated in FIG. 9A, the clearance S is maintained extensively between the retreating surface 16 of the mandrel 13 facing the second patterning tool 40B and the inner surface of the intermediate product 3. In this situation, therefore, the inner surface of the wider side wall of the intermediate product 3 is pushed onto the retreating surface 16. That is, the pressing force applied to the wider side wall of the intermediate product 3 from the second patterning tool 40B is absorbed by the clearance S. In addition, the inner surface of the portion of the intermediate product 3 which has already passed through the first patterning tool 40A and the second patterning tool 40B is also brought into contact with the retreating surface 16. Therefore, even if the metal M partially flows toward the portion of the intermediate product 3 which has already passed through the second patterning tool 40B, the metal M will not further flow inwardly toward the hollow space of the intermediate product 3 in the portion which has already passed through the second patterning tool 40B. For this reason, the inner surface of the intermediate product 3 may be shaped entirely into a flat surface. In other words, the inner surface of the intermediate product 3 will not be shaped into an uneven surface.

Thus, the pattern Da is applied sequentially to the outer surfaces of the narrower side walls of the intermediate product 3 by the first patterning tools 40A, and to the outer surfaces of the wider side walls of the intermediate product 3 by the second patterning tools 40B, until the product 4 having a designed length is produced.

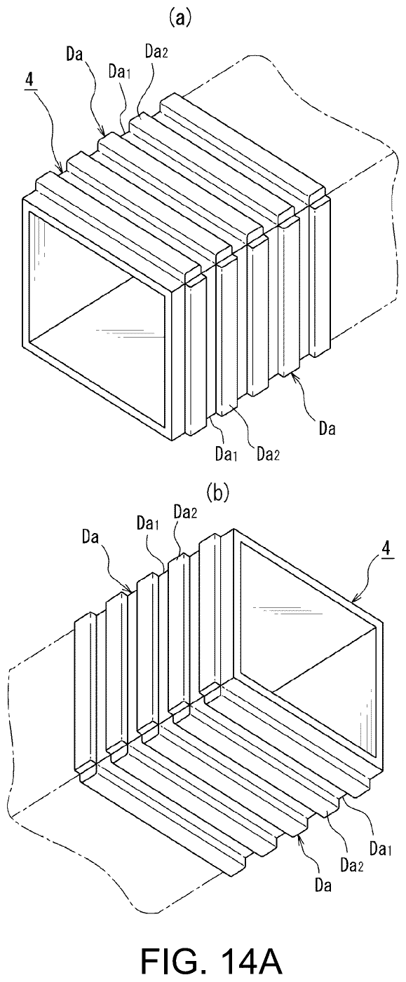

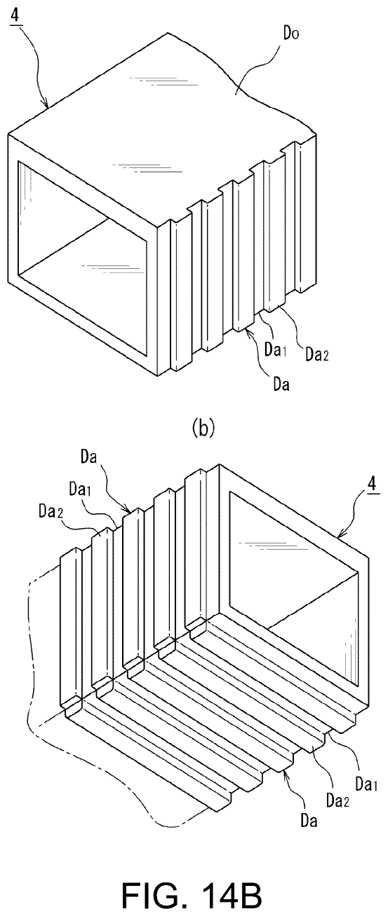

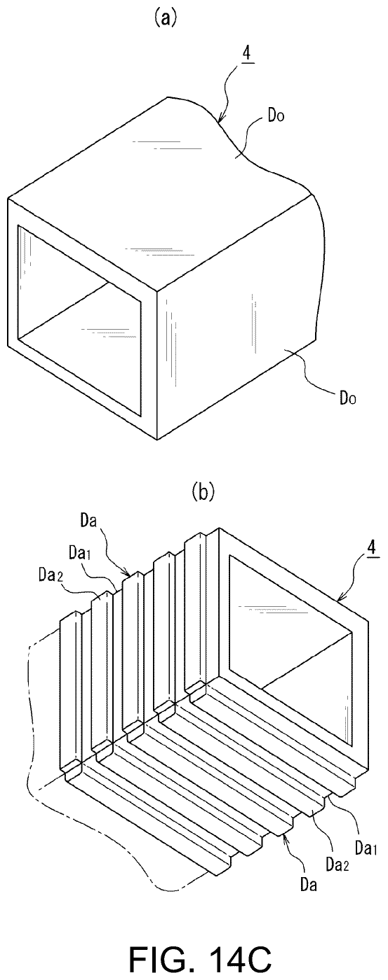

As illustrated in FIG. 14A, the pattern Da in which the transvers depressions Da1 and the transverse projections Da2 are juxtaposed alternately is applied to the outer surfaces of the wider and narrower side walls of the product 4 produced by the foregoing procedures.

Here will be explained the procedures for changing the positions of the first patterning tools 40A and the second patterning tools 40B with respect to the intermediate product 3. First of all, disassemble the extrusion die 1 into the upper die 10, the intermediate die 20, and the lower die 30, and dismount the first lower die 31 from the second lower die 37. For example, in a case of withdrawn the first patterning tool 40A (or the second patterning tool 40B) away from the intermediate product 3, turn the adjuster bolt 51 e.g., counterclockwise to allow the first plug 41 (or the second plug 42) to slide in the first recess 33 (or the second recess 35). Then, displace the first patterning tool 40A (or the second patterning tool 40B) toward the adjuster bolt 51, and insert the positioning spacer 52 selected to place the first patterning tool 40A (or the second patterning tool 40B) at a desired position between the inner side wall of the first plug 41 (or the second plug 42) and the inner side wall of the first recess 33 (or the second recess 35). Thereafter, turn the adjuster bolt 51 clockwise until the leading end of the adjuster bolt 51 comes into contact with the outer side wall of the first plug 41 (or the second plug 42).

According to the foregoing embodiment, same pattern Da is applied to all of the outer surface of the side walls of the product 4 by the extrusion die 1. Nonetheless, the extrusion die 1 according to the present invention should not be limited to the foregoing embodiment, and may be modified to apply different patterns to outer surfaces of different side walls of the product 4.

(a) According to the example of the product 4 shown in FIG. 14B, the pattern Da is applied to the outer surfaces of the narrower side walls and one of the wider side walls, and the outer surface of the other wider side wall is maintained to a plane surface D0. In order to manufacture the product 4 shown in FIG. 14B, a roller having a flat circumferential surface is adopted as one of the second patterning tools 40B. Consequently, the pattern Da may be applied to the outer surfaces of the narrower side walls and one of the wider side walls of the product 4, and the outer surface of the other wider side wall of the product 4 may be maintained to the plane surface D0.

(b) According to the example of the product 4 shown in FIG. 14C, the pattern Da is applied to the outer surfaces of one of the narrower side walls and one of the wider side walls, and the outer surfaces of the other narrower side wall and the other wider side wall are maintained to the plane surface D0. In order to manufacture the product 4 shown in FIG. 14C, the roller having a flat circumferential surface is adopted as one of the first patterning tool 40A and one of the second patterning tools 40B, respectively. Consequently, the pattern Da may be applied to the outer surfaces of one of the narrower side walls and one of the wider side walls of the product 4, and the outer surfaces of the other narrower side wall and the other wider side wall of the product 4 may be maintained to the plane surface D0.

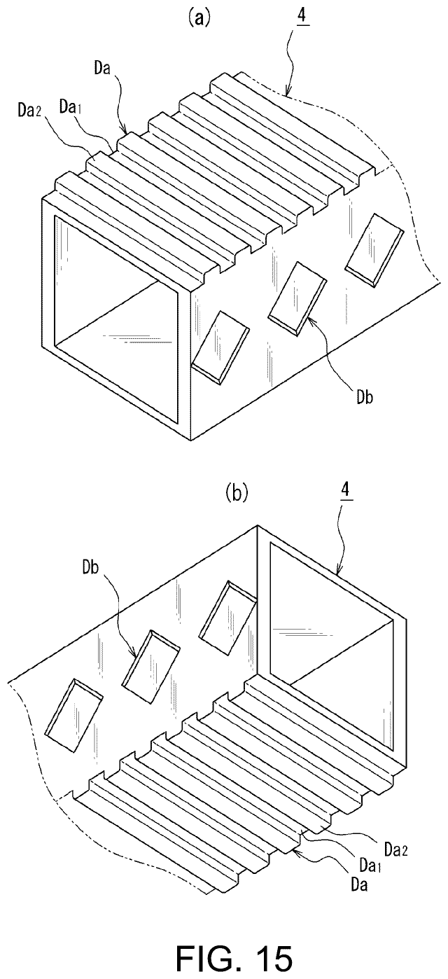

(c) According to the example of the product 4 shown in FIG. 15, a rhombus pattern Db in which rhombus depressions are formed intermittently is applied to the outer surfaces of the narrower side walls, and the pattern Da is applied to the outer surfaces of the wider side walls. In order to manufacture the product 4 shown in FIG. 15, a roller in which a plurality of rhombus projections is formed on the outer circumferential surface is adopted as each of the first patterning tools 40A, and the roller in which the set of teeth is formed on the outer circumference is adopted as each of the second patterning tools 40B. Consequently, the rhombus pattern Db may be applied to the outer surfaces of the narrower side walls of the product 4, and the pattern Da may be applied to the outer surfaces of the wider side walls of the product 4.

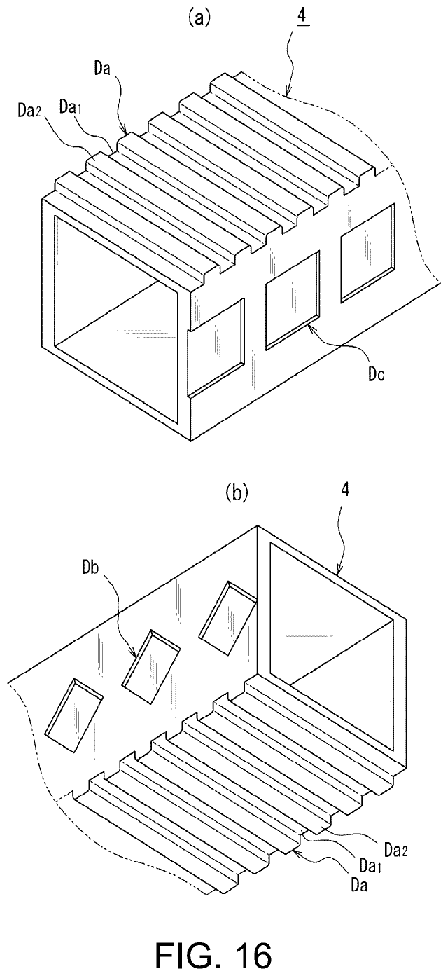

(d) According to the example of the product 4 shown in FIG. 16, the rhombus pattern Db is applied to the outer surface of one of the narrower side walls, a square pattern Dc in which square depressions are formed intermittently is applied to the outer surface of the other narrower side wall, and the pattern Da is applied to the outer surfaces of the wider side walls. In order to manufacture the product 4 shown in FIG. 16, the roller in which a plurality of rhombus projections is formed on the outer circumferential surface is adopted as one of the first patterning tools 40A, a roller in which a plurality of square projections is formed on the outer circumferential surface is adopted as the other first patterning tool 40A, and the roller in which the set of teeth is formed on the outer circumference is adopted as each of the second patterning tools 40B. Consequently, the rhombus pattern Db may be applied to the outer surface of one of the narrower side walls of the product 4, the square pattern Dc may be applied to the outer surface of the other narrower side wall of the product 4, and the pattern Da is applied to the outer surfaces of the wider side walls of the product 4.

The pattern to be applied to the outer surfaces of the product 4 should not be limited to the pattern Da, the rectangular pattern Db, and the square pattern Dc explained in the foregoing paragraphs (a) to (d). For example, circular depressions, triangle depressions, pentagonal depressions, and other kinds of polygonal depressions may also be applied to the outer surfaces of the product 4. In addition, configurations of the product 4 should not be limited to the foregoing configurations. In the foregoing embodiment, the mandrel having a rectangular cross-section is employed to manufacture the product 4 having a rectangular cross-section. However, for example, a mandrel having a square cross-section may also be employed to manufacture a product having a square cross-section.

Thus, according to the exemplary embodiment of the present invention, the pattern Da, Db, or Dc, or the plane surface D0 is applied to or formed on at least one of the outer surfaces of one of pairs of the opposing side walls of the intermediate product 3 by the first patterning tools 40A, and then, the pattern Da, Db, or Dc, or the plane surface D0 is applied to or formed on at least one of the outer surfaces of the other pair of the opposing side walls of the intermediate product 3 by the second patterning tools 40B. That is, the pattern Da, Db, or Dc, or the plane surface D0 may be applied to or formed on the intended side wall(s) sequentially.

Moreover, during application of the pattern Da, Db, or Dc, or the plane surface D0 by the first patterning tools 40A or the second patterning tool 40B, the pressing force applied to the side wall of the intermediate product 3 is absorbed by the clearance S, and the inner surface of the intermediate product 3 is brought into contact with the retreating surface 16. Therefore, the inner surface of the intermediate product 3 will not be deformed into a wavy shape.

Further, since the inner surface of the intermediate product 3 is pushed tightly onto the retreating surface 16, the metal M flown by the first patterning tools 40A and the second patterning tool 40B in the downstream side of the intermediate product 3 toward the hollow space is received by the retreating surface 16. Therefore, the inner surface of the intermediate product 3 may be prevented from being shaped into an uneven surface.

Furthermore, the first patterning tools 40A and the second patterning tool 40B may be selected arbitrarily from the above-mentioned tools for applying the patterns Da, Db, or Dc (or the tool for forming the plane surface D0), and those tools may be combined arbitrarily to apply a desired pattern(s) to a desired surface(es). Therefore, the desired pattern(s) including the plane surface may be applied to or formed on the desired surface(es) of the intermediate product 3 having the hollow structure.

In addition, positions of the first patterning tools 40A and the second patterning tool 40B with respect to the intermediate product 3 may be changed by manipulating the binding force adjusting mechanism. That is, the pressing force applied to the side walls of the intermediate product may be adjusted arbitrarily. Therefore, a depth of the transverse depressions Da1, the rectangular pattern Db, or the square pattern Dc to be applied to the intermediate product 3 may be adjusted arbitrarily. Moreover, the first patterning tools 40A and the second patterning tool 40B for applying the patterns Da, Db, or Dc may be set easily in the first lower die 31.

Although aluminum alloy is employed as the material of the product 4 in the foregoing embodiment, synthetic resin such as plastic e.g., PP (polypropylene) or PE (polyethylene), and engineering plastic e.g., PA (polyamide) may also be employed as the material of the product 4 instead of aluminum alloy.

In addition, the structure of the extrusion die 1 should not be limited to the foregoing upright structure in which the metal M is supplied thereto from above. For example, the extrusion die 1 may also be arranged horizontally, and the metal M may be supplied to the extrusion die 1 from the side.

1. An extrusion die for forming a patterned product that applies a pattern to a plurality of surfaces of a hollow intermediate product formed of thermoplastic material extruded continuously from a feeder, comprising:
an upper die to which the thermoplastic material is supplied, and which has a mandrel having a bearing to form a hollow space in the intermediate product;
an intermediate die having a bearing to shrink external dimensions of the intermediate product; and
a lower die supporting the upper die through the intermediate die,
wherein the lower die comprises:
a first lower die comprising
a first patterning tool that is rotated by a movement of the intermediate product to apply the pattern to at least one of outer surfaces of one of pairs of opposing side walls of the intermediate product, and
a second patterning tool that is rotated by the movement of the intermediate product to apply the pattern to at least one of outer surfaces of another pair of the opposing side walls of the intermediate product; and
a second lower die that is joined to the first lower die so as to fix the second patterning tool.

2. The extrusion die for forming the patterned product as claimed in claim 1,
wherein the first lower die of the lower die further comprises a lower guard surface that guides the intermediate product formed by the bearings, and
the mandrel comprises a retreating surface that absorbs pressing forces applied to the intermediate product from the first patterning tool and the second patterning tool.

3. The extrusion die for forming the patterned product as claimed in claim 2,
wherein the mandrel extends to a level lower than levels at which the first patterning tool and the second patterning tool roll on the intermediate product in the moving direction of the intermediate product, and
the retreating surface expands to a leading end of the mandrel.

4. The extrusion die for forming the patterned product as claimed in claim 1, wherein the first patterning tool and the second patterning tool are adapted to apply the same pattern to the outer surfaces of the intermediate product.

5. The extrusion die for forming the patterned product as claimed in claim 1, wherein the first patterning tool and the second patterning tool include a tool adapted to form a plane surface on the side wall of the intermediate product.

6. The extrusion die for forming the patterned product as claimed in claim 1, wherein the first patterning tool and the second patterning tool include tools adapted to apply different patterns to the outer surfaces of the intermediate product.

7. The extrusion die for forming the patterned product as claimed in claim 1, wherein the first patterning tool and the second patterning tool are arranged in the first lower die in a rotatable manner respectively, and positions of the first patterning tool and the second patterning tool with respect to the intermediate product may be adjusted respectively in the first lower die.

8. The extrusion die for forming the patterned product as claimed in claim 7,
wherein a bearing is fitted on each end of shafts of the first patterning tool and the second patterning tool,
a first plug is mounted on each of the bearings fitted on each end of the shaft of the first patterning tool, and a second plug is mounted on each of the bearings fitted on each end of the shaft of the second patterning tool,
each of the first plugs is fitted individually into a first recess formed on an upper surface of the first lower die, and each of the second plug is individually fitted into a second recess formed on a lower surface of the first lower die, and
the first lower die further comprises a binding force adjusting mechanism that adjust a binding force applied to each of the first patterning tool and the second patterning tool so as to allow the first patterning tool and the second patterning tool to slide toward and away from the intermediate product.
